(19) United States
(12) Patent Application Publication
(10) Pub. No.: US 2023/0235844 A1
(43) Pub. Date: Jul. 27, 2023

(54) PIPING SYSTEM INSERT COMPRISING AN ADAPTER FOR A PIPE ACCESS MEANS, AND METHOD FOR PIPING WORK

(71) Applicant: Stefan Sjöberg, Sölvesborg (SE)

(72) Inventor: Stefan Sjöberg, Sölvesborg (SE)

(21) Appl. No.: 18/002,102

(22) PCT Filed: Jun. 18, 2021
(86) PCT No.: PCT/IB2021/000407

§ 371 Date: Dec. 16, 2022

(30) Foreign Application Priority Data
Jun. 18, 2020 (SE) 2050734-9

(51) Int. Cl. F16L 55/105

(52) U.S. Cl. CPC F16L 55/105

(57) ABSTRACT

The invention relates to a conduit insert (1) comprising an adapter (10) having a liquid inlet (11) and a liquid outlet (12) and between them a chamber (13) having a first planar end wall into which the liquid inlet (11) opens, and an opposite second planar end wall, which is parallel to the first end wall and into which the liquid outlet (12) opens, and an access opening (16) extending from the first planar end wall of the chamber (13) to the second planar end wall of the chamber. A conduit access means (20) is slidable into and extractable out of the chamber (13) via the access opening (16) and has a first planar end face and an opposite second planar end face which is parallel to the first planar end face. The planar end faces are arranged to by means of respective elastic annular seals (27) round the liquid inlet (11) and the liquid outlet (12), respectively, in the chamber (13) to abut tightly against a respective planar end wall, wherein the elastic annular seals are (27) are permanently arranged in annular grooves (29) to enable insertion and extraction of the conduit access means (20) while pressurized liquid flows into the adapter (10) and its chamber (13) via the liquid inlet (11).

### TECHNICAL FIELD

The present invention relates to a conduit insert comprising an adapter, said adapter comprising a liquid inlet and a liquid outlet and between these a chamber comprising a first planar end wall, into which the liquid inlet opens, and an opposite second planar end wall, which is parallel to the first the end wall and into which the liquid outlet opens, and an access opening extending from the first planar end wall of the chamber to the second planar end wall of the chamber, wherein a conduit access means is provided, which is slidable into and extractable out of the chamber via the access opening and comprises a first planar end face and an opposite second planar end face parallel to the first planar end face, wherein the first planar end face is arranged to abut tightly against the first planar end wall of the chamber around the liquid inlet by means of an elastic annular seal arranged in an annular groove in the first planar end face, and wherein the second planar end face is arranged to abut tightly against the second planar end wall of the chamber around the liquid outlet by means of an elastic annular seal arranged in an annular groove in the second planar end face.

The invention further relates to a method for piping work in a conduit insert, which is located in the ground and comprises a well pipe.

### PRIOR ART

From SE 516 230 C2 a conduit insert is known which reflects the preamble. The known conduit insert is intended to be located in the ground and is distinguished by the fact that it enables piping work, such as changing of a valve, through a simple extraction and insertion move from ground level via a well pipe.

### OBJECT OF THE INVENTION

In practice, it has shown that the known conduit insert significantly facilitates piping work by making it possible to easy extract and insert a conduit access means, such as a valve. For this, however, it is required that the liquid supply to the conduit insert is stopped at another location, since flowing liquid risks disturbing placement of the annular seals. This causes leakage either because the annular seal is damaged or because it does not fit snugly as intended.

Against that background, the object of the invention is to improve the known conduit insert in such a way that its possibilities of use are extended and its function is improved.

### SUMMARY OF THE INVENTION

According to the present invention this object is achieved by means of a conduit insert which comprises the features of the preamble and is characterized in that the elastic annular seals are permanently attached to the annular grooves to enable insertion and extraction of the conduit access means while pressurized liquid flows into the adapter and its chamber.

The solution according to the present invention has the advantages that it is easier to work with and that it is more robust and more reliable than the previous solution.

According to a preferred embodiment, the elastic annular seals are permanently fixed in the annular grooves in the end faces in that the annular grooves are undercut with a narrower annular opening in the respective end face and a wider annular space below the respective end face, wherein the elastic annular seals are pressed into respective annular grooves past the narrower annular opening of the annular groove to be permanently retained in the wider annular space of the annular groove. It is understood that such a solution is easy to achieve and that it has the advantage that no glue or the like needs to be used to achieve the permanent retention.

Preferably, the elastic annular seals are O-rings which have a larger cross-section than the width of the opening of the annular groove. O-rings are extremely robust and are available in many different dimensions as standard. In other words, it is easy to find suitable seals on the market for this purpose.

In cross-section the space in the respective annular groove is preferably trapezoidal, with the narrower annular opening at the top and below a flat bottom, which is wider than the cross-section of an O-ring. An undercut annular groove designed in this way enables easy mounting and safe retainment of an O-ring.

According to a preferred embodiment, the chamber of the adapter comprises a first planar side wall extending between the two end walls of the chamber and an opposite second planar side wall extending between the two end walls of the chamber and parallel to the first side wall, wherein the access opening extends from the first planar side wall of the chamber to the second planar side wall of the chamber, wherein the conduit access means comprises a first planar side wall portion extending from the first end face of the conduit access means to the second end face of the conduit access means, and an opposite second planar side wall portion extending from the first end face of the conduit access means to the second end face of the conduit access means and parallel to the first side wall portion, and wherein on each side wall of the chamber beads are arranged near the end walls, which beads extend from the access opening into the chamber and are arranged to, when inserting the conduit access means into the chamber, be in contact with the side wall portions of the conduit access means to guide the conduit access means into place in the chamber. The side walls easily ensure that the conduit access means is guided into place inside the chamber when it is pushed into it, wherein the beads help to minimize friction and impact from contaminants, such as grains of sand, in the chamber. Incidentally, the latter purpose can also be served by a bottom pocket in the chamber under the conduit access means providing an extra space in the chamber for such contaminants.

Normally, the conduit adapter is intended to be used in a water supply system, the adapter being located in the ground and being tightly connected to a well pipe extending above ground level and having a diameter greater than the largest horizontal dimension of the conduit access means. In such a solution, the adapter can be located at a depth of, for example, 2 m in the ground and still, with the aid of a rod-shaped tool, enable easy handling of the conduit access means from ground level.

Preferably, a pipe, which on a side comprises a liquid outlet, is above ground connected to the well pipe. The advantage of this pipe is that it makes it possible to divert water from the well pipe when the well pipe during work is filled with liquid which flows into the adapter via the liquid inlet of the adapter. Preferably, a plate of heat insulating material is removably inserted into the well pipe above the conduit access means. Through this simple measure, it is possible to reliably protect the conduit insert and possible connected units against frost.

According to one embodiment, the conduit access means may comprise a channel extending between the two end faces of the conduit access means, wherein a non-return valve is provided in the channel to allow or prevent flow of liquid from the fluid inlet of the adapter to the fluid outlet of the adapter. This solution is extremely simple and reliable and makes it possible to use one and the same conduit access means for two opposite objects. Alternatively, the two opposite objects could also be achieved by means of two different conduit access means, one of which has a continuous channel and one that lacks such a channel. And a third alternative, provided that the chamber of the adapter is substantially square, could consist of a similarly substantially square conduit access means, which in 90 degree rotational steps of one and the same conduit access means allows, respectively, prevents flow of liquid from the adapter inlet to the adapter fluid outlet.

According to another embodiment, the conduit access means comprises a closed wall portion, which is arranged in and blocks a channel, which extends between the two end surfaces of the conduit access means, wherein the conduit access means comprises connections connecting the channel with a pipe or a hose for directing a flow of liquid from the fluid inlet of the adapter to the fluid outlet of the adapter. A desired unit can be connected to such a pipe or hose, as for example a flow meter, which fits into the well pipe and preferably is remotely readable on site inside this pipe.

Alternatively, the pipe or hose is a flexible hose, which has such a length that a flow meter without disconnection of the flexible hose can be lifted out of the well pipe in order to enable manual reading.

It is also possible to connect a non-return valve to the pipe or hose in order to allow or prevent a flow of liquid from the liquid inlet of the adapter to the liquid outlet of the adapter, depending on the rotational position of the conduit access means. In other words, the non-return valve entails the same advantages as the previously mentioned non-return valve but entails the additional advantage that it can be combined with an additional unit, such as said flow meter.

The conduit insert of the present invention enables significantly simplified piping work when the conduit insert is located in the ground and includes a well pipe, thanks to a method which includes insertion and pulling of a conduit access means into and out of the adapter chamber while pressurized liquid is allowed to flow into the adapter and its chamber via the liquid inlet. In practice, this means that prior to such piping work, it is not necessary to locate a shut-off valve upstream of the conduit insert and instead the intended work can be started directly on site without delay.

As a step in the method according to the present invention, when a conduit access means is inserted into the chamber of the adapter, it is also possible to empty the well pipe of liquid from above, which can be done, for example, by means of a pump or wet vacuum cleaner.

### BRIEF DESCRIPTION OF THE DRAWINGS

The invention is schematically illustrated in the accompanying drawings, in which:

FIG. 1 shows a conduit access means, half in a side view and half in a sectional view;

FIG. 2 shows the conduit access means in an end view;

FIG. 3 shows an adapter, half in a side view and half in a longitudinal sectional view;

FIG. 4 shows an adapter with a conduit access means inserted therein, half in a side view and in half in a longitudinal sectional view;

FIG. 5 shows an alternative embodiment of a conduit access means, half in a side view and half in a longitudinal sectional view;

FIG. 6 shows an alternative embodiment of a conduit access means in a longitudinal sectional view;

FIG. 7 shows an alternative embodiment of a conduit access means, half in a side view and half in a longitudinal sectional view;

FIGS. 8 and 9 show a pipeline insert together with a well pipe partly in section and in two different positions of use; and

FIGS. 10 and 11 show the adapter and the well pipe partly in section while the well pipe is filled with liquid via the adapter.

### DESCRIPTION OF PREFERRED EMBODIMENTS

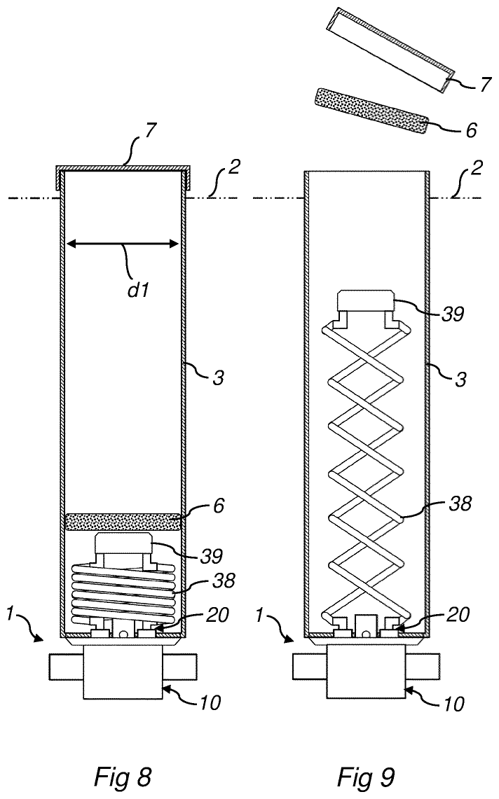

The conduit insert 1 according to the present invention is preferably intended for water supply systems and is preferably, as shown in FIGS. 8-11, located in ground 2. Two components which are always included in the conduit insert 1 are in accordance with FIG. 4 an adapter 10, which has a liquid inlet 11 and a liquid outlet 12, which are connected to the water supply system, and a conduit access means 20, which is slidable into and extractable from a chamber 13 in the adapter 10 via an access opening 16 arranged at the top of the chamber 13.

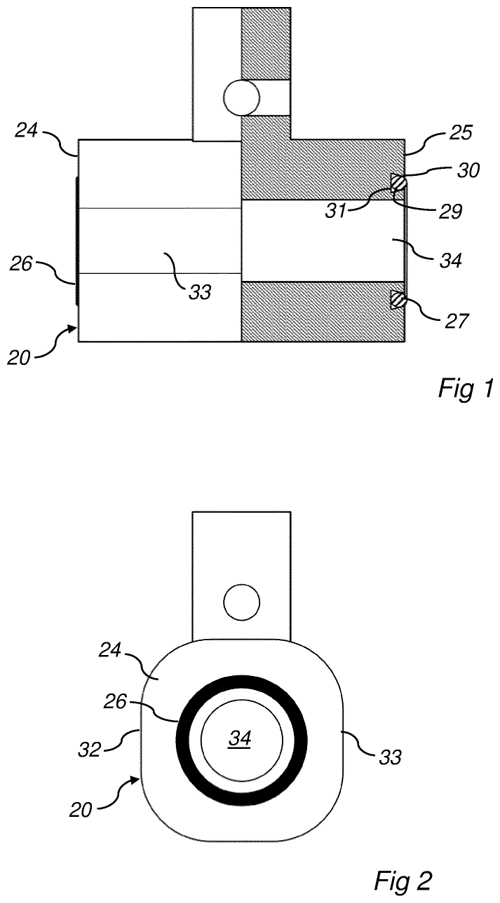

The conduit access means 20, which in different embodiments is shown separately in FIGS. 1, 2 and 5-7, consists of a solid body of e.g. plastic and comprises a first planar end face 24 and an opposite second planar end face 25, which is parallel to the first planar end face 24. In the first planar end face 24 there is an annular groove 28, in which an elastic annular seal 26 in the form of an O-ring is arranged, and in the second end face 25 there is an annular groove 29, in which an elastic annular seal 27 in the form of an O-ring is arranged.

The annular grooves 28, 29 are trapezoidally undercut and have a narrower annular opening 30 in the respective end surface 24, 25 and below the respective end surface 24, 25 a wider annular space 31. The undercut makes it possible to permanently mount the annular seals 26, 27 without, for example, glue in the respective annular grooves 28, 29 by simply pressing the annular seals 26, 27 past the narrow annular openings 30 of the annular grooves 28, 29 into the wider annular spaces 31 of the annular grooves 28, 29.

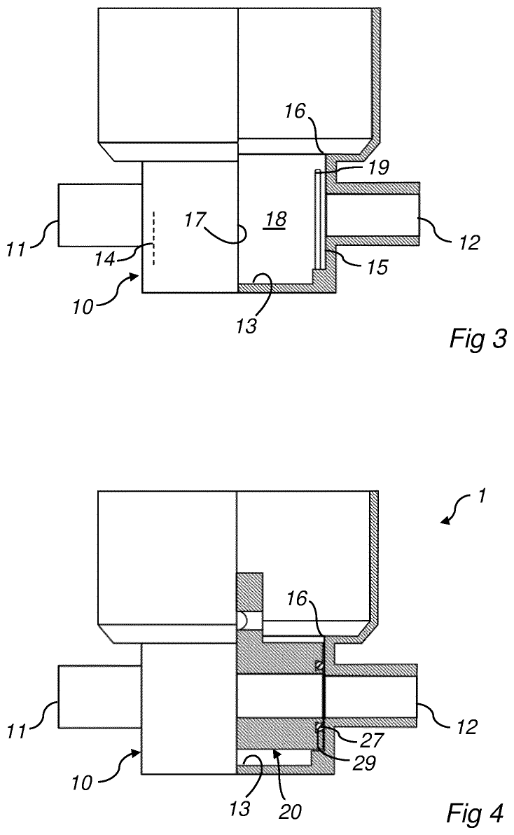

The adapter 10 is shown separately only in FIG. 3, while in FIGS. 4 and 8-11 it is shown together with other units. From FIG. 3 it can be seen that the adapter 10 comprises a housing, which is preferably made in one piece of plastic. It has on one side the above-mentioned liquid inlet 11 and opposite on the other side the above-mentioned liquid outlet 12. The liquid inlet 11 and the liquid outlet 12 open inside the adapter 10 into the chamber 13, which is rectangular in shape seen from above.

The chamber 13 is defined by a first planar end wall 14, in which the liquid inlet 11 opens substantially centrally, and an opposite second planar end wall 15, which is parallel to the first end wall 14 and in which the liquid outlet 12 opens substantially centrally. The chamber 13 is further defined by a first planar side wall 17, which extends between the two end walls 14, 15 of the chamber 13, and an opposite second planar side wall 18, which extends between the two end walls 14, 15 of the chamber 13 and is parallel to the first side wall 17.

On the respective side wall 17, 18 there are vertical beads 19 which are arranged near the end walls 14, 15. The beads 19 are arranged such that when inserting and extracting the conduit access means 20 into and out of the chamber 13 via the access opening 16 in contact with flat side wall portions 32, 33 on the conduit access means 20 the conduit access means 20 is guided in place inside the chamber 13 with minimal friction.

When inserting and extracting the conduit access means 20, which is suitably performed by means of a rod-shaped tool, which is not shown and which can engage with a key grip at the top of the conduit access means 20, not only the side wall portions 32, 33 slide along said beads 19 but also the end surfaces of the conduit access means 20 with their elastic annular seals 26, 27 along the respective end wall 14, 15 in the chamber 13. In this case the arrangement is such that, when the conduit access means 20 reaches the bottom of the chamber 13, the annular seals 26, 27 respectively are centered and tightly enclose each liquid inlet or liquid outlet mouth in the chamber 13.

According to a first embodiment, illustrated in FIG. 1, the conduit access means 20 comprises a central channel 34, which extends between the two end faces 24, 25 of the conduit access means 20 and opens centrally inside the respective annular seal 26, 27. Thus, through the channel 34, liquid can flow freely from the liquid inlet 11 of the adapter 10 to its liquid outlet 12, for example to release water to a property.

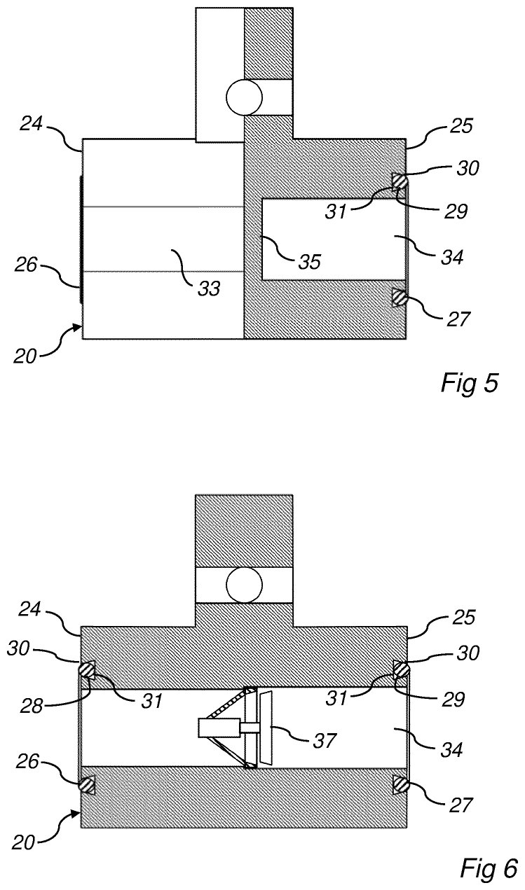

According to a second embodiment, illustrated in FIG. 5, the conduit access means 20 comprises a central channel 34, which between the two end faces 24, 25 of the conduit access means 20 is blocked by a wall 35. The wall 35 prevents liquid from flowing from the liquid inlet 11 to the liquid outlet 12 of the adapter 10, which means that this embodiment of the pipe access means 20 can, for example, be used to stop the supply of water to a property.

According to a third embodiment, illustrated in FIG. 6, the conduit access means 20 comprises a central channel 34, which extends between the two end faces 24, 25 of the conduit access means 20 and opens centrally inside the respective annular seal 26, 27. In the middle of the channel 34 there is a non-return valve 37, which is arranged to allow or prevent flow of liquid from the liquid inlet 11 of the adapter 10 to the liquid outlet 12 of the adapter 10 depending on the rotational position of the conduit access means 20. This embodiment of the conduit access means 20 can thus be used as a single unit to optionally, for example, allow or turn off supply of water to a property.

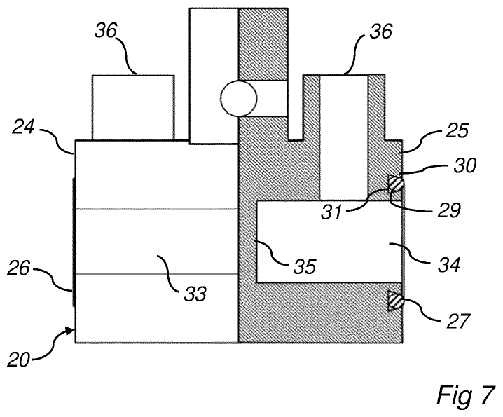

According to a fourth embodiment, illustrated in FIG. 7, the conduit access means 20 comprises a central channel 33, which extends between the two end faces 24, 25 of the conduit access means 20 and opens centrally inside the respective annaular seal 26, 27. In the middle of the channel 33 there is a wall 32, which is arranged in and blocks the channel 33. However, the channel 33 has at the top connections 36 on either side of the wall 32. These connections 36 can for instance be used to connect the channel 34 to a pipe or a hose 38 (cf. FIGS. 8 and 9) for directing a flow of liquid from the liquid inlet 11 of the adapter 10 to the liquid outlet 12 of the adapter 10, whereby an optional unit can be easily connected to this pipe or hose 38.

Such an optional unit may, for example, be a flow meter 39, shown schematically in FIGS. 8 and 9 in connection with a well pipe 3, which extends from a ground level 2 into the ground to a conduit insert 1, which according to the invention comprises an adapter 10, to which the well pipe 3 connects tightly, and a conduit access means 20, which corresponds to the fourth embodiment above. In this case, it is important to point out that the well pipe 3 must always have a diameter dl which is larger than the largest horizontal dimension of the conduit access means 20. This is so that the conduit access means 20 can be lifted out of the well pipe 3 without hindrance and can be lowered into it.

The flow meter 39 can either, as illustrated in FIGS. 8 and 9, be of a type which requires manual reading and is therefore connected with a long flexible hose 38, which enables lifting of the flow meter 39 to ground level 2, or of a remote readable type, which can mounted by means of a fixed pipe or a shorter hose. Regardless of the solution chosen, it is suitable to in cold climates removably insert in the well pipe a sheet 6 of a heat-insulating material into the well pipe 3 above the conduit access means 10 and also to always close the well pipe 3 by means of a safety cover 7.

In this context it should also be mentioned that it is also possible to connect a non-return valve corresponding to the previously described non-return valve 37 in the pipe or hose 38.

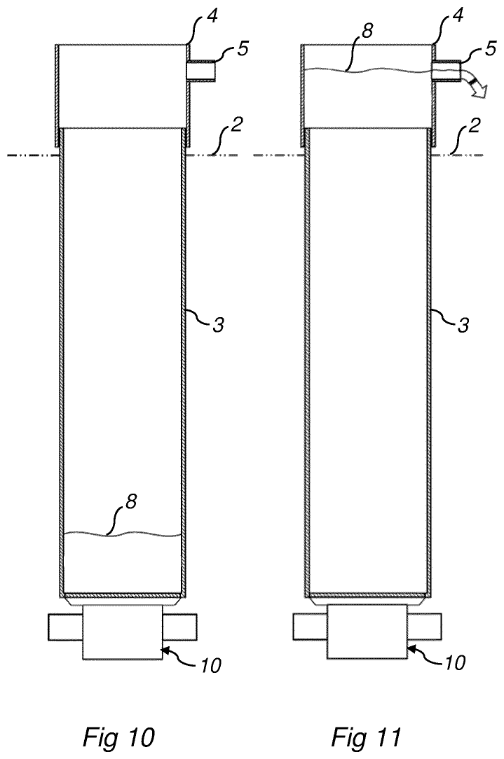

FIGS. 10 and 11 show an attachment in the form of a pipe 4, which above ground 2 is tightly connectable to the well pipe 3 and on a side has an outlet 5. The pipe 4 with the outlet 5 is used in piping work, which includes insertion and extraction of a conduit access means 20 into and out of the chamber 13 and which according to the invention is accomplished while pressurized liquid 8 is allowed to flow into the adapter 10 and its chamber 13 via the liquid inlet 11. During such piping work the well pipe 3 can over time be completely filled with liquid and flooded. Then the outlet 5 comes in handy, because it makes it possible to divert the liquid away from the workplace, which thus can be kept dry. When the piping work has been completed and no more liquid flows into the well pipe 3, it is easily possible to empty the well pipe by means of a pump or preferably a wet vacuum cleaner.

1. A conduit insert comprising an adapter, said adapter comprising a liquid inlet and a liquid outlet and between these a chamber comprising a first planar end wall, in which the liquid inlet opens, and an opposite second planar end wall, which is parallel to the first end wall and in which the liquid outlet opens, and an access opening extending from the first planar end wall of the chamber to the second planar end wall of the chamber, wherein a conduit access means is provided, which is slidable into and extractable out of the chamber via the access opening and comprises a first planar end face and an opposite second planar end face which is parallel to the first planar end face, wherein the first planar end face is by means of an elastic annular seal arranged in an annular groove in the first planar end face is arranged to tightly abut against the first planar end wall of the chamber around the liquid inlet, and wherein the second planar end face is by means of an elastic annular seal arranged in an annular groove in the second planar end face to tightly abut against the second planar end wall of the chamber around the liquid outlet, wherein the elastic annular seals are permanently attached to the annular grooves to enable insertion and extraction of the conduit access means while pressurized liquid flows into the adapter and its chamber via the liquid inlet.

2. The conduit insert according to claim 1, wherein the elastic annular seals are permanently fixed in the annular grooves in the end faces by the annular grooves being undercut with a narrower annular opening in respective end face and below the respective end faces a wider annular space, wherein the elastic annular seals are pressed into the respective annular grooves past the narrower annular openings of the annular grooves to be permanently retained in the wider annular spaces of the annular grooves.

3. The conduit insert according to claim 2, wherein the elastic annular seals are O-rings which have a larger cross-section than the width of the opening of the annular groove.

4. The conduit insert according to claim 3, wherein, when seen in cross section, the annular groove is trapezoidal with the narrower annular opening at the top and below a flat bottom which is wider than a cross section of an O-ring.

5. The conduit insert according to claim 1, wherein the chamber of the adapter comprises a first planar side wall extending between the two end walls of the chamber, and an opposite second planar side wall, which extends between the two end walls of the chamber and is parallel to the first side wall, wherein the access opening extends from the first planar side wall of the chamber to the second planar side wall of the chamber, wherein the conduit access means comprises a first planar side wall portion extending from the first end face of the conduit access means to the second end face of the conduit access means, and an opposite second flat side wall portion extending from the first end face of the conduit access means to the second end face of the conduit access means and parallel to the first side wall portion, and wherein beads are arranged on the respective side wall of the chamber near the end walls, wherein the beads extend from the access opening into the chamber and are arranged such that they upon insertion of the conduit access means into the chamber come into contact with the side wall portions of the conduit access means to guide the conduit access means into place in the chamber.

6. The conduit insert according to claim 1 wherein the adapter is located in the ground and is tightly connected to a well pipe, which extends above ground level and has a diameter which is larger than the largest horizontal dimension of the conduit access means.

7. The conduit insert according to claim 6, wherein a pipe, which on a side has a liquid outlet, above ground is connectable to the well pipe.

8. The conduit insert according to claim 6, wherein a plate of heat-insulating material is removably inserted into the well pipe above the pipe access means.

9. The conduit insert according claim 6, wherein the conduit access means comprises a channel extending between the two end faces of the conduit access means, wherein a non-return valve is provided in the channel for allowing or preventing a flow of liquid from the liquid inlet of the adapter to the liquid outlet of the adapter depending on the rotational position of the conduit access means.

10. The conduit insert according to claim 6, wherein the conduit access means comprises a closed wall portion arranged in and blocking a channel extending between both end surfaces of the conduit access means, wherein the conduit access means comprises connections connecting the channel to a pipe or hose for directing a flow of liquid from the liquid inlet of the adapter to the liquid outlet of the adapter.

11. The conduit insert according to claim 10, wherein a flow meter, which fits into the well pipe , is connected in the pipe or hose.

12. The conduit insert according to claim 11, wherein the pipe or hose is a flexible hose, which has such a length that the flow meter can be lifted out of the well pipe without disconnecting the flexible hose.

13. The conduit insert according to claim 10, wherein a non-return valve is connected to the pipe or hose to allow or prevent a flow of liquid from the liquid inlet of the adapter to the liquid outlet of the adapter dependent on a rotational position of the conduit access means.

14. A method for piping work involving a conduit insert according to claim 1, wherein the pipeline insert is located in the ground.

15. The method according to claim 14, wherein the well pipe, when a conduit access means has been inserted into the chamber of the adapter, is emptied of liquid from above.

16. The method according to claim 14, comprising a well pipe according to claim 6, wherein piping work involving insertion and extraction of a conduit access means into and out of the chamber of the adapter is performed while pressurized liquid flows into the adapter and its chamber via the liquid inlet.

17. The method according to claim 16, wherein the well pipe, when a conduit access means has been inserted into the chamber of the adapter, is emptied of liquid from above.
